(19) United States
(12) Patent Application Publication
(10) Pub. No.: US 2002/0165922 A1
(43) Pub. Date: Nov. 7, 2002

(54) Application based screen sampling

(76) Inventor: Songxiang Wei, Mountain View, CA (US)

Correspondence Address: SKJERVEN MORRILL LLP, 25 METRO DRIVE, SUITE 700, SAN JOSE, CA, 95110, US

(21) Appl. No.: 09/835,079

(22) Filed: Apr. 13, 2001

(51) Int. Cl. G06F 15/16

(52) U.S. Cl. 709/205; 345/753

(57) ABSTRACT

A method for sharing an application is disclosed. The method includes determining a position and a size of a shared application window by monitoring function calls made by the application, and capturing a screen shot of an image corresponding to the shared application window.

### CROSS-REFERENCE TO RELATED PATENT APPLICATIONS

This Application is related to co-pending U.S. patent application Ser. No. ______, entitled “Sharing OpenGL Applications Using Application Based Screen Sampling,” filed on Apr. 13, 2001 and having Attorney Docket Number M-11126 US, and U.S. patent application Ser. No. ______ entitled “Sharing DirectDraw Applications Using Application Based Screen Sampling,” filed on Apr. 13, 2001 and having Attorney Docket Number M-11127 US, both of which are incorporated herein by reference in their entirety.

### BACKGROUND OF THE INVENTION

1. Field of the Invention

The present invention relates to data conferencing systems, and more particularly, to the sharing of applications during a data conference.

2. Related Art

Data conferencing systems allow computer users at different locations to communicate via a computer network and share applications stored and/or executed on one of the user's computers. Each user's computer includes a data conferencing software program that enables the users to share applications. Users that share applications during a data conference are referred to herein as presenters. Users that receive the shared applications during a data conference are referred to herein as viewers.

A conventional technique for sharing applications during a data conference is to share a predefined area of the presenter's computer screen with a viewer. Using this technique, the presenter's computer captures an image within a predefined portion of the presenter's computer screen (e.g., the entire computer screen or a rectangular portion of the computer screen). The captured image within the predefined portion of the presenter's computer screen is then transmitted to the viewer's computer. The viewer's computer then displays the transmitted image on the viewer's computer screen. Thus, replicas of any windows that are displayed within the predefined portion of the presenter's computer screen are displayed on the viewer's computer screen.

A disadvantage of this application sharing technique is that all application windows displayed within the predefined portion of the presenter's computer screen (e.g., the entire computer screen or a rectangular portion of the computer screen) are captured and transmitted to the viewer. There is no way for the presenter to selectively share application windows with the viewer. Thus, the presenter must be careful not to have application windows placed within the predefined portion of the presenter's computer screen if the presenter does not want to share such windows.

What is needed is an improved method for sharing applications during a data conference.

### SUMMARY OF THE INVENTION

The present invention provides an improved method for sharing applications during a data conference.

The method of the present invention includes determining a position and a size of a shared application window by monitoring function calls made by the application, and capturing a screen shot of an image corresponding to the shared application window.

Other embodiments, aspects, and advantages of the present invention will become apparent from the following descriptions, the accompanying drawings, and the accompanying claims.

### BRIEF DESCRIPTION OF THE DRAWINGS

For a more complete understanding of the present invention and for further embodiments, aspects, and advantages, reference is now made to the following description taken in conjunction with the accompanying drawings, in which:

FIG. 1 is a block diagram of an exemplary data conferencing system, according to some embodiments of the present invention.

FIG. 2 is a flowchart of an exemplary application based screen sampling method, according to some embodiments of the present invention.

FIGS. 3A and 3B show a presenter's computer screen and a viewer's computer screen, respectively, during a data conference, according to some embodiments of the present invention.

FIG. 3 is a flowchart of an exemplary OpenGL application based screen sampling method, according to some embodiments of the present invention.

FIGS. 5A and 5B show a presenter's computer screen and a viewer's computer screen, respectively, during a data conference, according to some embodiments of the present invention.

FIG. 6 is a flowchart of an exemplary DirectDraw application based screen sampling method, according to some embodiments of the present invention.

FIGS. 7A and 7B show a presenter's computer screen and a viewer's computer screen, respectively, during a data conference, according to some embodiments of the present invention.

### DETAILED DESCRIPTION OF THE INVENTION

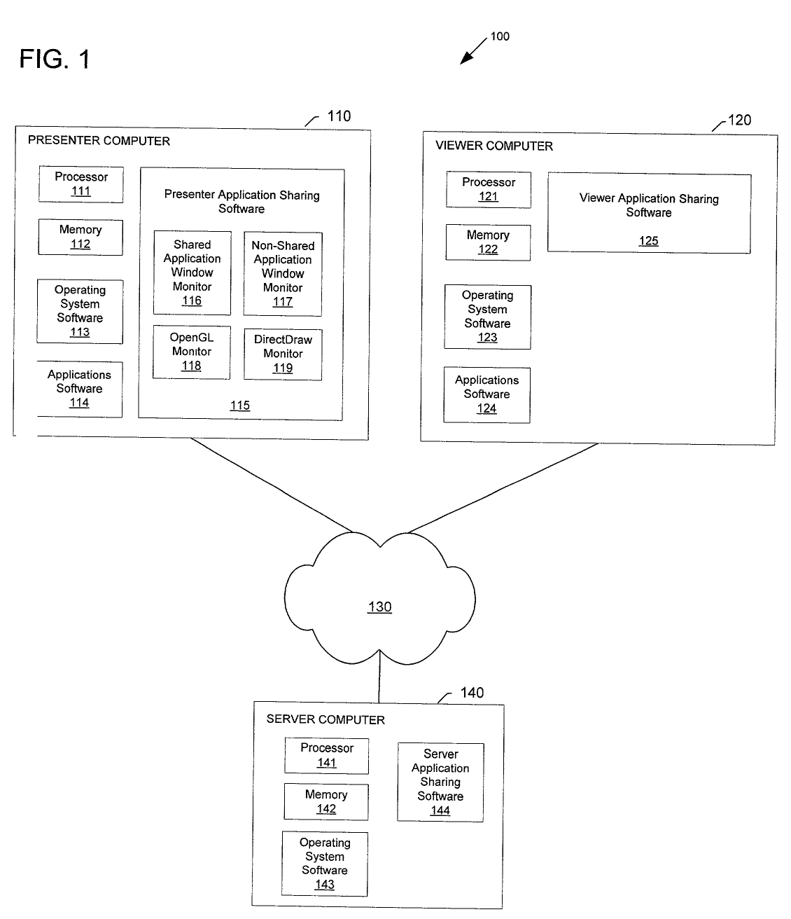

The preferred embodiments of the present invention and their advantages are best understood by referring to FIGS. 1 through 7 of the drawings. Like reference numerals are used for like and corresponding components of the various drawings. As used herein, the term shared application window refers to a window belonging to an application that a presenter intends to share with a viewer, and the term non-shared application window refers to a window belonging to an application that a presenter does not intend to share with a viewer.

### Data Conferencing System

FIG. 1 is a block diagram of an exemplary data conferencing system 100, according to some embodiments of the present invention. A presenter computer 110 is connected to a server computer 140 via a global area computer network 130. A viewer computer 120 is connected to server computer 140 via global area computer network 130. A presenter can use presenter computer 110 to connect to server computer 140. Once connected, the presenter can start a data conference. A viewer can use viewer computer 120 to connect to server computer 140. Once connected, the viewer can join the data conference started by the presenter. Once the data conference has been established, the presenter can, among other things, share applications with the viewer. For clarity, system 100 is depicted with only a single presenter computer 110, a single viewer computer 120, and a single server computer 140. It should be recognized, however, that multiple presenter computers 110, multiple viewer computers 120, and multiple server computers 140 can be used with the present invention. It should also be recognized that presenter computer 110 and/or viewer computer 120 can be any type of electronic devices that are capable of communicating with one another and displaying an image on a screen. For example, presenter computer 110 and/or viewer computer 120 can be personal digital assistants (PDAs), cellular telephones, or other like devices.

Presenter computer 110 includes processor 111, memory 112, operating system software 113, applications software 114, and presenter application sharing software 115. Processor 111 can be any suitable processor, such as a member of the Pentium family of processors. Memory 112 can be any type of suitable memory, such as DRAM, SRAM, a magnetic hard drive, an optical hard drive, or any combination thereof. Operating system software 113 can be any type of suitable operating system software, such as Microsoft Windows-based operating system software. Applications software 114 can be a word processing application, a spreadsheet application, a computer aided drafting application, or any other type of application.

Presenter application sharing software 115 can be any type of suitable software that enables presenters and viewers to share applications, documents, or the like. Presenter application sharing software 115 includes the following software components: shared application window monitor 116, non-shared application window monitor 117, OpenGL monitor 118, and DirectDraw monitor 119. The function of each of these software components is discussed in detail below. Presenter application sharing software 115 also includes other software components that are not shown or discussed for clarity. An example of presenter application sharing software 115 is a downloadable plug-in provided by WebEx Communications, Inc. of San Jose, Calif.

Viewer computer 120 includes processor 121, memory 122, operating system software 123, and applications software 124, which are similar to processor 111, memory 112, operating system software 113, and applications software 114, of presenter computer 110. Viewer computer 120 also includes viewer application sharing software 125, which can be similar to or the same as presenter application sharing software 115. Viewer application sharing software 125, among other things, receives images of application windows from the presenter's computer and displays the images on the viewer's computer screen.

Server computer 140 includes a processor 141, memory 142, operating system software 143 and server application sharing software 144. Server application sharing software 144 can be any type of suitable software that allows presenters and viewers to conduct data conferences.

Details of data conferencing system 100 are further described in the following United States Patent Applications and Patents, each of which is incorporated herein by reference in its entirety: “Distributed Network System Architecture For Collaborative Computing,” co-pending and commonly-assigned Application for a U.S. Pat. Ser. No. 09/751,424, filed Dec. 29, 2000; “Fault-Tolerant Distributed System For Collaborative Computing,” co-pending and commonly-assigned Application for a U.S. Pat. Ser. No. 09/751,807, filed Dec. 29, 2000; “Scalable Distributed System For Collaborative Computing,” co-pending and commonly-assigned Application for a U.S. Pat. Ser. No. 09/751,548, filed Dec. 29, 2000; “Distributed Meeting Management,” co-pending and commonly-assigned Application for a U.S. Pat. Ser. No. 09/751,595, filed Dec. 29, 2000; “Fault Tolerant Server Architecture For Collaborative Computing,” co-pending and commonly-assigned Application for a U.S. Pat. Ser. No. 09/752,376, filed Dec. 29, 2000; “Distributed Application Sharing,” co-pending and commonly-assigned Application for a U.S. Pat. Ser. No. 09/751,806, filed Dec. 29, 2000; “Distributed Document Sharing,” co-pending and commonly-assigned Application for a U.S. Pat. Ser. No. 09/753,193, filed Dec. 29, 2000; “Secure Communications System For Collaborative Computing,” co-pending and commonly-assigned Application for a U.S. Pat. Ser. No. 09/752,284, filed Dec. 29, 2000; “Fault Tolerant Server For Collaborative Computing,” co-pending and commonly-assigned Application for a U.S. Pat. Ser. No. 09/751,519, filed Dec. 29, 2000; “Quality Of Service Maintenance For Distributed Collaborative Computing,” co-pending and commonly-assigned Application for a U.S. Pat. Ser. No. 09/752,377, filed Dec. 29, 2000; “Instant Document Sharing,” co-pending and commonly-assigned Application for a U.S. Pat. Ser. No. 09/442,424, filed Nov. 17, 1999; “Instant Sharing of Documents in a Viewer Server,” co-pending and commonly-assigned Application for U.S. Pat. Ser. No. 09/471,938, filed Dec. 23, 1999; “Viewer Document Serving,” co-pending and commonly-assigned Application for a U.S. Pat. Ser. No. 09/591,377, filed Jun. 9, 2000; “Instantaneous Viewer Control of an Unattended Server,” co-pending and commonly-assigned Application for a U.S. Pat. Ser. No. 09/515,684, filed Feb. 29, 2000; “Method for Creating Peer-to-Peer Connections Over an Interconnected Network to Facilitate Conferencing Among Users,” co-pending and commonly-assigned Application for a U.S. Pat. Ser. No. 08/609,025, filed on Feb. 29, 1996; “Method for Establishing a Communication Connection Between Two or More Users Via a Network of Interconnected Computers,” co-pending and commonly-assigned Application for a U.S. Pat. Ser. No. 09/195,801, filed on May 12, 2000; “Emulating a Persistent Connection Using HTTP,” co-pending and commonly-assigned Application for a U.S. Pat. Ser. No. 09/449,011, filed on Nov. 24, 1999; “Method of Transferring Data at Adjustable Levels of Priorities to Provide Optimum Response to User Demands,” U.S. Pat. No. 5,623,603; “Method to Provide for Virtual Screen Overlay,” U.S. Pat. No. 5,577,188; and “Collaborative Web Browser,” U.S. Pat. No. 5,944,791.

### Application Based Screen Sampling

The present invention provides an improved method for sharing applications during a data conference. As mentioned above, conventional application sharing techniques capture a predefined portion of the presenter's computer screen (e.g., the entire screen or a rectangle within the entire screen) and provide the image within the predefined portion of the presenter's computer screen to the viewer. All of the applications that have windows positioned within the predefined portion of the presenter's computer screen are captured by the presenter's computer, transmitted to the viewer's computer, and displayed on the viewer's computer screen whether or not the presenter intended to share these application windows with the viewer. As a result, the presenter may inadvertently share an application window with a viewer that the presenter does not intend to share with the viewer. As described below, the application sharing method of the present invention overcomes these disadvantages.

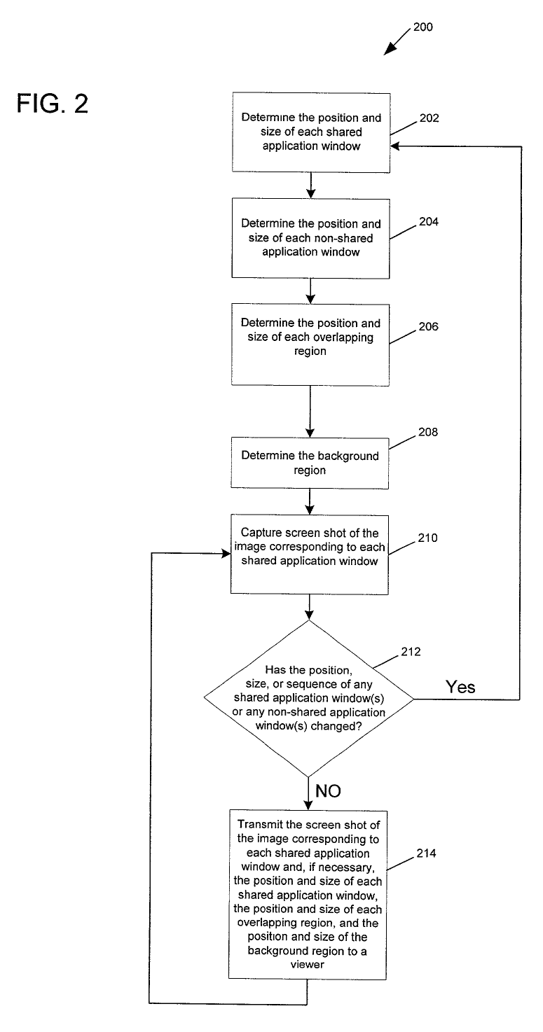

FIG. 2 is a flowchart of an exemplary application based screen sampling method 200, according to some embodiments of the present invention. Method 200 is performed during a data conference. Method 200 assumes that the presenter has pre-defined or pre-designated an application as a shared application during the data conference.

In step 202, the position and the size of each shared application window is determined. If the shared application only has one window, the position and size of this window is determined. If the shared application has several windows, the position and size of each of these windows is determined.

The position and size of each shared application window can be determined dynamically by monitoring and intercepting function calls made by the shared application to a graphics display subsystem. The graphics display subsystem receives the function calls and, in response, causes appropriate graphics or images to be drawn on the presenter's computer screen. For example, if the application is running on a Microsoft Windows based computer, the application may call Graphics Device Interface (GDI) functions to draw images on the presenter's computer screen. The function calls provide information that identifies which application a particular window belongs to, the position of the window, and the size of the window. Thus, by monitoring and intercepting the function calls, the position and size of a window can be determined. This step can be performed by shared application window monitor 116 (FIG. 1).

If the presenter's computer is operating in a Windows environment, the position and size of each shared application window can be determined by monitoring the “GetRandomRgn” function. The GetRandomRgn function prototype is as follows:

int GetRandomRgn (HDC hdc, HRGN hrgn, INT iNum)

Microsoft Corp. first published the GetRandomRgn function prototype with the release of Windows 2000. However, in this publication Microsoft Corp. did not provide a definition for iNum. The publication stated that iNum must be SYSRGN (a predefined value). Applicant has discovered that, by setting inum to the value 4, the visible region of a window can be determined. For example, the following process can be used to determine the visible region of a hypothetical window hWnd:

HDC hdc=GetWindowDC(hWnd) 11 of the window Get the graphic context

HRGN hRegion=CreateRectRgn (0, 0, 0, 0) 11 Create an empty region

GetRandomRgn (hDC, hRegion, 4) 11 hRegion is now the visible region of the window

In step 204, the position and the size of each non-shared application window is determined. If the non-shared application only has one window, the position and size of this window is determined. If the non-shared application has several windows, the position and size of each of these windows is determined.

The position and size of each non-shared application window can be determined dynamically by monitoring and intercepting function calls made by the non-shared application to a graphics display subsystem (as described in step 202 above). This step can be performed by non-shared application window monitor 117 (FIG. 1).

In step 206, the position and size of each overlapping region is determined. An overlapping region is a region on the presenter's computer screen where a non-shared application window overlaps a shared application window. If none of the non-shared application windows overlap shared application windows, there are no overlapping regions. If multiple non-shared application windows overlap shared application windows, there are multiple overlapping regions.

The position and size of each overlapping region can be determined by comparing the position and size of each shared application window with the position and size of each non-shared application window.

In step 208, the background region is determined. The background region is the area on the presenter's computer screen that is not occupied by a shared application window. The background region includes areas of the presenter's computer screen that are occupied by non-shared application windows.

The background region can be determined by comparing the position and size of each shared application window with the position and size of the presenter's entire computer screen.

In step 210, a screen shot of the image corresponding to each shared application window is captured. In this step, the image within each shared application window is captured so that it can be provided to the viewer. This step is performed periodically (e.g., five times per second) so that changes to the image on the presenter's computer screen are immediately reflected on the viewer's computer screen.

The screen shot of the image corresponding to each shared application window can be captured by capturing portions of the frame buffer on the presenter's computer that correspond to shared application windows. Since step 202 determines the sizes and positions of the shared application windows, the location of the shared application windows within the frame buffer are known.

In step 212, the position, size, and sequence of each shared application window and each non-shared application window is monitored. If the position, size, or sequence of a shared application window or a non-shared application window changes, then method 200 returns to step 202. If the position, size, and sequence of the shared application windows and the non-shared application windows do not change, then method 200 proceeds to step 214.

The position, size, and sequence of each shared application window and each non-shared application window on the presenter's computer screen can be dynamically monitored by monitoring and intercepting function calls made by the shared and non-shared applications to a graphics display subsystem (as described in step 202 above).

In step 214, the screen shot of the image corresponding to each shared application window and, if necessary, the position and size of each shared application window, the position and size of each overlapping region, and the position and size of the background region is transmitted to the viewer's computer. If the position, size, and sequence of the shared application windows and the non-shared application windows have not changed since the previous screen shot was transmitted to the viewer's computer, then the position and size of the shared application windows, the position and size of the overlapping regions, and the position and size of the background region do not have to be retransmitted to the viewer's computer. On the other hand, if the position, size, or sequence of the shared application windows or the non-shared application windows have changed since the previous screen shot was transmitted to the viewer's computer, then the updated position and size of the shared application windows, the updated position and size of the overlapping regions, and/or the updated position and size of the background region are transmitted to the viewer's computer. This ensures that the viewer's computer screen accurately reflects what is currently displayed on the presenter's computer screen. Prior to transmission, the screen shot of the images corresponding to each shared application window can be compressed using image compression techniques such as GZIP or JPEG.

Once the viewer's computer has received the screen shot of the image corresponding to each shared application window, and if transmitted, the position and size of each shared application window, the position and size of each overlapping region, and the position and size of the background region, viewer application sharing software 125 can display the image on the viewer's computer screen. To accomplish this, viewer application software 125 performs the following process. First, viewer application software 125 generates or draws a background region based on the position and size of the background region. The background region can be filled or painted with an arbitrary color or image. Second, viewer application software 125 generates or draws a window corresponding to the position and size of each shared application window. Third, viewer application sharing software 125 generates or draws the image corresponding to each shared application window inside of each shared application window. Fourth, viewer application software 125 generates or draws an overlapping region corresponding to the position and size of each overlapping region. The overlapping region can be filled or painted with an arbitrary color or image. Skilled artisans will recognize that this process can be modified to achieve the same result and that all such modifications are within the scope of the present invention.

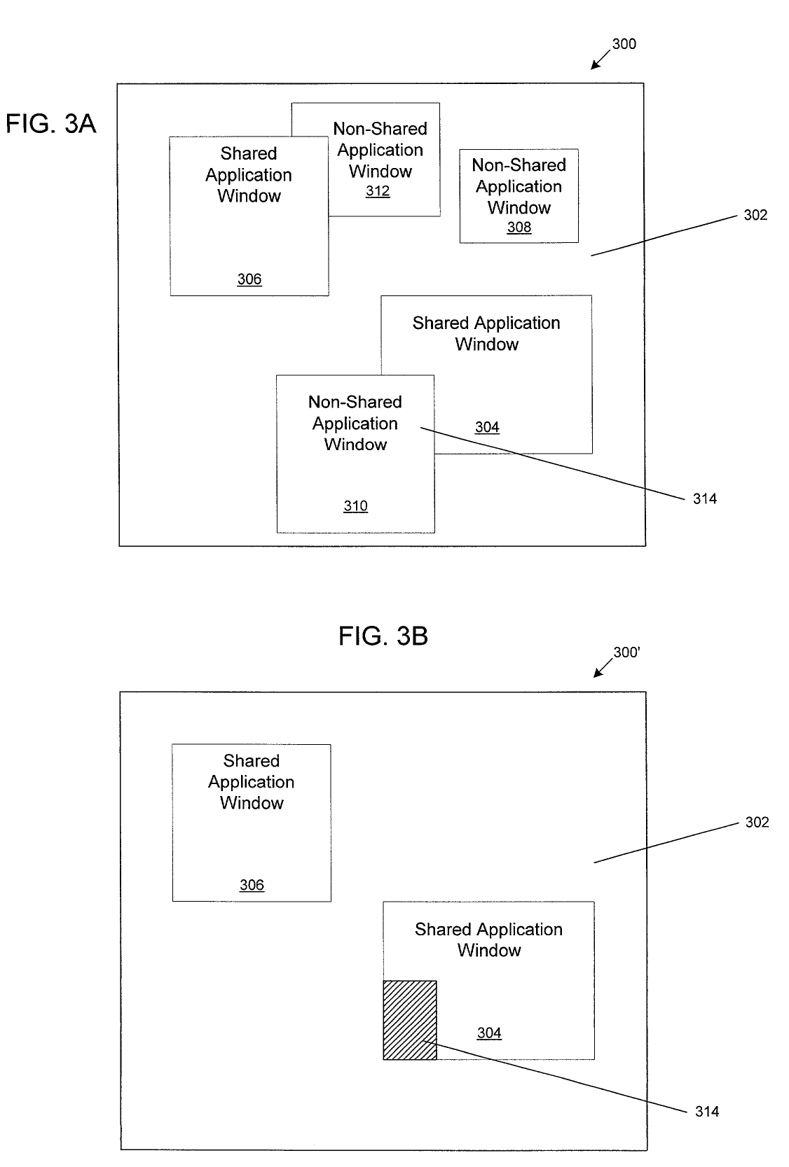

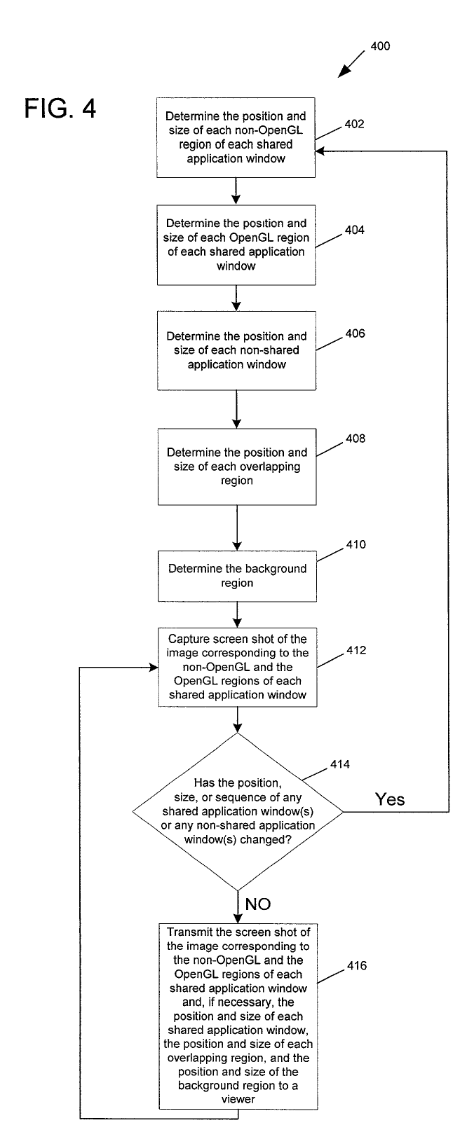

FIGS. 3A and 3B show an example of how application based screen sampling method 200 operates during a data conference. FIG. 3A shows a presenter's computer screen 300. Presenter's computer screen 300 includes background region 302, shared application windows 304 and 306, non-shared application windows 308, 310, and 312, and overlapping region 314. FIG. 3B shows a viewer's computer screen 300′. Viewer's computer screen 300′ includes background region 302, shared application windows 304 and 306, and overlapping region 314.

After a data conference has started, the presenter selects one or more applications to share with a viewer. Presenter application sharing software 115 receives the presenter's selections and then performs the application based sharing method of the present invention as follows. First, presenter application sharing software 115 determines the position and size of each shared application window on the presenter's computer screen 300 (step 202). To accomplish this, shared application window monitor 116 monitors appropriate function calls that define the positions and sizes of shared application windows 304 and 306. Second, presenter application sharing software 115 determines the position and size of each non-shared application window on the presenter's computer screen 300 (step 204). To accomplish this, non-shared application window monitor 117 monitors appropriate function calls that define the position and size of non-shared application windows 308, 310, and 312. Third, presenter application sharing software 115 determines the position and size of the overlapping regions (step 206). Presenter application sharing software 115 can determine this by comparing the position and size of shared application window 304 with the position and size of non-shared application window 310. Note that the portion of shared application window 306 that overlaps non-shared application window 312 is not an overlapping region since non-shared application window 312 does not overlap shared application window 306. Fourth, presenter application sharing software 115 determines the background region 302 (step 208). Presenter application sharing software 115 can determine the background region by comparing the positions and sizes of shared application windows 304 and 306 with the position and size of the entire computer screen 300. Fifth, presenter application sharing software 115 captures a screen shot of image within shared application windows 304 and 306 (step 210). Presenter application sharing software 115 can perform this step by capturing a screen shot that corresponds to the position and size of shared application windows 304 and 306. Sixth, presenter application sharing software 115 determines whether the position, size, or sequence of any shared application windows or of any non-shared application windows has changed (step 212). Presenter application sharing software 115 can perform this step by monitoring function calls that define the position, size, and sequence of shared application windows 304 and 306 and non-shared application windows 308, 310, and 312. Since the position, size and sequence of the shared application windows and the non-shared application windows have not changed in this example, the presenter application sharing software 115 proceeds to the next step in the process (i.e., step 214). Seventh, presenter application sharing software 115 transmits the screen shot of the image within shared application windows 304 and 306, and, if necessary, the position and size of shared application windows 304 and 306, the position and size of overlapping region 314, and position and size of the background region 302 (step 214). This example assumes that the position and size of shared application windows 304 and 306, the position and size of overlapping region 314, and position and size of background region 312 do not change. Thus the position and size of shared application windows 304 and 306, the position and size of overlapping region 312, and position and size of the background region 302 only need to be transmitted to the viewer's computer once. After that, only the updated screen shots of image within shared application windows 304 and 306 on the presenter's computer screen need to be periodically transmitted to the viewer's computer.

Application based screen sampling method 200 provides at least the following advantages. First, it allows a presenter to define or designate applications as shared applications and non-shared applications. Windows belonging to shared applications and non-shared applications are monitored and only windows belonging to shared application are displayed on a viewer's computer screen. Thus the presenter does not have to worry about inadvertently sharing an application window or a portion of an application window that the presenter does not intend to share with a viewer. Second, the presenter can now intentionally obscure a portion of a shared application window by placing a non-shared application window over the shared application window.

### OpenGL Application Based Screen Sampling

The present invention provides an improved method for sharing applications that use OpenGL during a data conference. OpenGL is a well-known application program interface (API) that is used by applications to draw graphics (e.g., 2D and 3D graphics) on a presenter's computer screen. To generate graphics using OpenGL, an application first launches OpenGL. The application then calls OpenGL functions. As a result of these function calls, OpenGL internally calls glFlash, glDraw, and/or glEscape, which are OpenGL subsystems. Finally, the gIFlash, glDraw, or glEscape subsystems cause the graphics to be drawn on the presenter's computer screen.

FIG. 4 is a flowchart of an exemplary OpenGL application based screen sampling method 400, according to some embodiments of the present invention. Method 400 is performed during a data conference. Method 400 assumes that the presenter has pre-defined or pre-designated an application as a shared application during the data conference.

In step 402, the position and size of each non-OpenGL region of each shared application window is determined. The non-OpenGL regions are the areas within shared application windows that are not drawn by OpenGL. If the shared application only has one window, the position and size of the non-OpenGL regions in this window are determined. If the shared application has several windows, the position and size of the non-OpenGL regions in each of these windows is determined.

The position and size of each non-OpenGL region of each shared application window can be determined dynamically by monitoring and intercepting function calls made by the shared application to a graphics display subsystem (as described in step 202 above).

In step 404, the position and size of each OpenGL region of each shared application window is determined. The OpenGL regions are the areas within the shared application windows that are drawn by OpenGL. If the shared application only has one window, the position and size of the OpenGL regions in this window are determined. If the shared application has several windows, the position and size of the OpenGL regions in each of these windows are determined.

The position and size of the OpenGL regions of each shared application window can be determined dynamically by monitoring and intercepting OpenGL function calls made by the application. For example, the position and size of the OpenGL regions of each window belonging to a shared application can be determined dynamically by monitoring and intercepting function calls to the glFlash, glDraw, and glEscape subsystems of OpenGL. Thus, by monitoring and intercepting the function calls made to OpenGL or to the glFlash, glDraw, and/or glEscape subsystems of OpenGL, the position and size of each OpenGL region within a shared application window can be determined. This step can be performed by OpenGL monitor 118 (FIG. 1).

In step 406, the position and size of each non-shared application window is determined. If the non-shared application only has one window, the position and size of this window is determined. If the non-shared application has several windows, the position and size of each of these windows are determined.

The position and size of the non-shared application windows can be determined dynamically by monitoring and intercepting function calls made by the shared application to a graphics display subsystem (as described in step 202 above).

In step 408, the position and size of each overlapping region is determined. An overlapping region is a region on the presenter's computer screen where a non-shared application window overlaps a non-OpenGL region or an OpenGL region of a shared application window. If none of the non-shared application windows overlap non-OpenGL regions or OpenGL regions of shared application windows, there are no overlapping regions. If multiple non-shared application windows overlap non-OpenGL regions or OpenGL regions of shared application windows, there are multiple overlapping regions.

The position and size of each overlapping region can be determined by comparing the position and size of the non-OpenGL and the OpenGL regions of each shared application window with the position and size of each non-shared application window.

In step 410, the background region is determined. The background region is the area on the presenter's computer screen that is not occupied by a shared application window (i.e., not a non-OpenGL or OpenGL region). The background region includes areas of the presenter's computer screen that are occupied by non-shared application windows.

The background region can be determined by comparing the position and size of the non-OpenGL and the OpenGL regions of each shared application window with the position and size of the presenter's entire computer screen.

In step 412, a screen shot of the image corresponding to the non-OpenGL and OpenGL regions of each shared application windows is captured. In this step, the image within each shared application window (i.e., the non-OpenGL and OpenGL regions) is captured so that it can be provided to the viewer. This step is performed periodically (e.g., five times per second). Thus, as the image on the presenter's computer screen changes, these changes are immediately reflected on the viewer's computer screen.

The screen shot of the image corresponding to non-OpenGL and OpenGL regions can be captured by capturing portions of the frame buffer on the presenter's computer that correspond to the non-OpenGL and OpenGL regions. Since step 402 and 404 determines the sizes and positions of the non-OpenGL and OpenGL regions of shared application windows, the location of the shared application windows within the frame buffer are known.

In step 414, the position, size, and sequence of each shared application window and each non-shared application window is monitored. If the position, size, or sequence of a shared application window or a non-shared application window changes, then method 400 returns to step 402. If the position, size, and sequence of the shared application windows and the non-shared application windows do not change, then method 400 proceeds to step 412.

The position, size, and sequence of each shared application window and each non-shared application window on the presenter's computer screen can be dynamically monitored by monitoring and intercepting function calls made by the shared application to a graphics display subsystem (as described above).

In step 416, the screen shot of the image corresponding to the non-OpenGL and the OpenGL regions of each shared application window, if necessary, the position and size of each shared application window, the position and size of each overlapping region, and the position and size of the background region is transmitted to the viewer's computer. If the position, size, and sequence of the shared application windows and the non-shared application windows have not changed since the previous screen shot was transmitted to the viewer's computer, then the position and size of the shared application windows, the position and size of the overlapping regions, and the position and size of the background region do not have to be retransmitted to the viewer's computer. On the other hand, if the position, size, or sequence of the shared application windows or the non-shared application windows have changed since the previous screen shot was transmitted to the viewer's computer, then the updated position and size of the shared application windows, the updated position and size of the overlapping regions, and/or the updated position and size of the background region are transmitted to the viewer's computer. This ensures that the viewer's computer screen accurately reflects what is currently displayed on the presenter's computer screen. Prior to transmission, the screen shot of the images corresponding to each shared application window can be compressed using image compression techniques such as GZIP or JPEG.

Once the viewer's computer has received the screen shot of the image corresponding to the non-OpenGL and the OpenGL regions of each shared application window, and if transmitted, the position and size of each shared application window, the position and size of each overlapping region, and the position and size of the background region, viewer application sharing software 125 can display the image on the viewer's computer screen. To accomplish this, viewer application software 125 performs the following process. First, viewer application software 125 generates or draws a background region based on the position and size of the background region. The background region can be filled or painted with an arbitrary color or image. Second, viewer application software 125 generates or draws a window corresponding to the position and size of each shared application window. Third, viewer application sharing software 125 generates or draws the image corresponding to the non-OpenGL and the OpenGL regions of each shared application window inside of each shared application window. Fourth, viewer application software 125 generates or draws an overlapping region corresponding to the position and size of each overlapping region. The overlapping region can be filled or painted with an arbitrary color or image. Skilled artisans will recognize that this process can be modified to achieve the same result and that all such modifications are within the scope of the present invention.

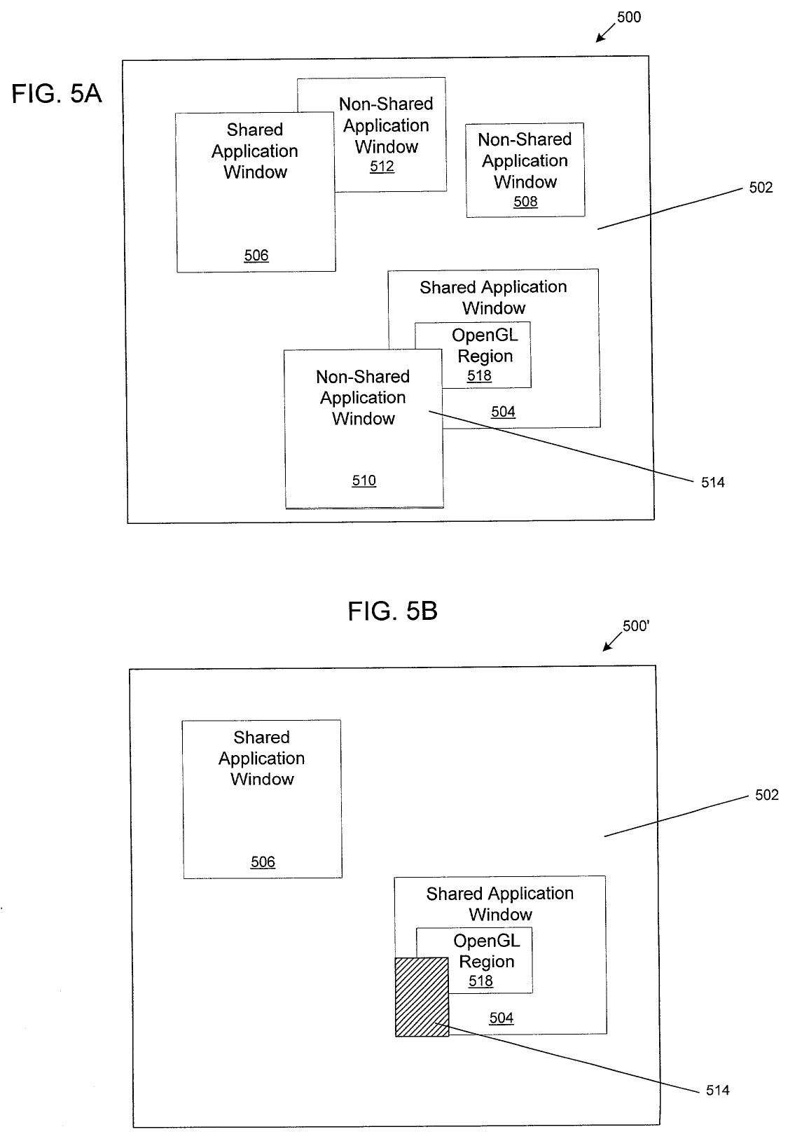

FIGS. 5A and 5B show an example of how application based screen sampling method 400 operates during a data conference. FIG. 5A shows a presenter's computer screen 500. Presenter's computer screen 500 includes background region 502, shared application windows 504 and 506, non-shared application windows 508, 510, and 512, and overlapping region 514. Shared application window 504 includes an OpenGL region 518, which is a region drawn by OpenGL. The region of shared application window 504 outside of OpenGL region 518 is referred to as the non-OpenGL region, which is a region that is not drawn by OpenGL. FIG. 5B shows a viewer's computer screen 500′. Viewer's computer screen 500′ includes background region 502, shared application windows 504 and 506, and overlapping region 514. Shared application window 504 includes OpenGL region 518. A portion of OpenGL region 518 and non-OpenGL region of shared application window 504 is obscured by overlapping region 514.

After a data conference has started, the presenter selects one or more applications to share with a viewer. Presenter application sharing software 115 receives the presenter's selections and then performs the OpenGL application based sharing method of the present invention as follows. First, presenter application sharing software 115 determines the position and size of the non-OpenGL regions within each shared application window on the presenter's computer screen 500 (step 402). To accomplish this, shared application window monitor 116 monitors function calls that define the positions and sizes of the non-OpenGL regions of shared application windows 504 and 506. Second, presenter application sharing software 115 determines the position and size of the OpenGL regions within each shared application window on the presenter's computer screen 500 (step 404). To accomplish this, OpenGL monitor 118 monitors OpenGL function calls made by the application that define the positions and sizes of the OpenGL regions of shared application window 504. Third, presenter application sharing software 115 determines the position and size of each non-shared application window on the presenter's computer screen 500 (step 406). To accomplish this, non-shared application window monitor 117 monitors function calls that define the positions and sizes of non-shared application windows 508, 510, and 512. Fourth, presenter application sharing software 115 determines the position and size of the overlapping regions (step 408). Presenter application sharing software 115 can determine the overlapping regions by comparing the position and size of non-OpenGL regions and the OpenGL regions of shared application window 504 with the position and size of non-shared application window 510. Note that the portion of shared application window 506 that overlaps non-shared application window 512 is not an overlapping region since non-shared application window 512 does not overlap shared application window 506. Fifth, presenter application sharing software 115 determines the background region 502 (step 410). Presenter application sharing software 115 can determine the background region by comparing the positions and sizes of shared application windows 504 and 506 with the position and size of the entire computer screen 500. Sixth, presenter application sharing software 115 captures a screen shot of the image within non-OpenGL and the OpenGL regions of the shared application windows (step 412). Presenter application sharing software 115 can perform this step by capturing a screen shot of the image that corresponds to the position and size of shared application windows 504 and 506 (including the non-OpenGL and the OpenGL regions). Seventh, presenter application sharing software 115 determines whether the position, size or sequence of any shared application windows or any non-shared application windows have changed (step 414). Presenter application sharing software 115 can perform this step by monitoring function calls that define the position, size, and sequence of shared application windows 504 and 506 and non-shared application windows 508, 510, and 512. Since the position, size and sequence of the shared application windows and the non-shared application windows have not changed in this example, the presenter application sharing software 115 proceeds to the next step of the process (i.e., step 416). Eighth, presenter application sharing software 115 transmits the screen shots of the image within non-OpenGL and the OpenGL regions of shared application windows 504 and 506, and, if necessary, the position and size of shared application windows 504 and 506, the position and size of overlapping region 514, and position and size of background region 502 (step 416). This example assumes that the position and size of shared application windows 504 and 506, the position and size of overlapping region 514, and position and size of background region 502 do not change. Thus the position and size of shared application windows 504 and 506, the position and size of overlapping region 508, 510, and 512, and position and size of background region 502 only need to be transmitted to the viewer's computer once. After that, only the updated screen shots of the image within shared application windows 504 and 506 on the presenter's computer screen need to be periodically transmitted to the viewer's computer.

Application based screen sampling method 400 provides at least the following advantages. First, it allows a presenter to define or designate applications as shared applications and non-shared applications. Windows belonging to shared applications and non-shared applications are monitored and only windows belonging to shared application windows are displayed on a viewer's computer screen. Thus the presenter does not have to worry about inadvertently sharing an application window or a portion of an application window that the presenter does not intend to share with a viewer. Second, the presenter can now intentionally obscure a portion of a shared application window by placing a non-shared application window over the shared application window. Third, the presenter can share applications that generate images using OpenGL.

### DirectDraw Application Based Screen Sampling

The present invention provides an improved method for sharing applications that use DirectDraw during a data conference. DirectDraw is a well-known Windows-based API used to create 2D graphics. Many applications use DirectDraw to draw graphics on a presenter's computer screen. Unlike OpenGL and other general windows APIs, DirectDraw is COM based. To generate graphics using DirectDraw, an application first launches DirectDraw. The application then gets the COM interfaces corresponding to DirectDraw. Next, the application calls the DirectDraw COM interface to access the DirectDraw functions. Finally, the DirectDraw COM interface calls an internal function to render the graphics.

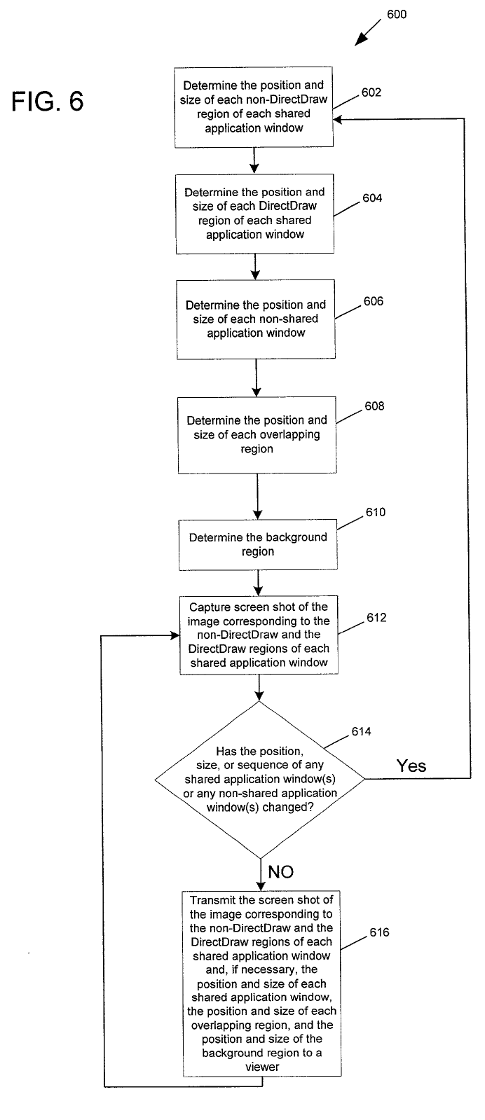

FIG. 6 is a flowchart of an exemplary DirectDraw application based screen sampling method 600, according to some embodiments of the present invention. Method 600 is performed during a data conference. Method 600 assumes that the presenter has pre-defined or pre-designated an application as a shared application during the data conference.

In step 602, the position and size of each non-DirectDraw region of each shared application window is determined. The non-DirectDraw regions are the areas within shared application windows that are not drawn by DirectDraw. If the shared application only has one window, the position and size of the non-DirectDraw regions in this window are determined. If the shared application has several windows, the position and size of the non-DirectDraw regions in each of these windows are determined.

The position and size of each non-DirectDraw regions of each shared application window can be determined dynamically by monitoring and intercepting function calls made by the shared application to a graphics display subsystem (as described in step 202 above).

In step 604, the position and size of each DirectDraw region of each shared application window is determined. The DirectDraw regions are the areas within the shared application windows that are drawn by DirectDraw. If the shared application only has one window, the position and size of the DirectDraw regions in this window are determined. If the shared application has several windows, the position and size of the DirectDraw regions in each of these windows are determined.

The position and size of each DirectDraw region of each shared application window can be determined by monitoring the DirectDraw COM interface. As mentioned above, DirectDraw is not like OpenGL and other general windows APIs; DirectDraw is COM based. Since Direct Draw is COM based, it is not possible to monitor function calls made by the application directly to DirectDraw to determine the position and size of each DirectDraw region of each shared application window. However, Applicant has discovered that the position and size of each DirectDraw region of each shared application window can be determined by dynamically monitoring the, DirectDraw COM interface and intercepting information that defines the position and size of each DirectDraw region of each shared application window. This step can be performed by DirectDraw monitor 119 (FIG. 1).

In step 606, the position and size of each non-shared application window is determined. If the non-shared application only has one window, the position and size of this window is determined. If the non-shared application has several windows, the position and size of each of these windows are determined.

The position and size of the non-shared application windows can be determined dynamically by monitoring and intercepting function calls made by the shared application to a graphics display subsystem (as described in step 202 above).

In step 608, the position and size of each overlapping region is determined. An overlapping region is a region on the presenter's computer screen where a non-shared application window overlaps a non-DirectDraw region or a DirectDraw region of a shared application window. If none of the non-shared application windows overlap non-DirectDraw regions or DirectDraw regions of shared application windows, there are no overlapping regions. If multiple non-shared application windows overlap non-DirectDraw regions or DirectDraw regions of shared application windows, there are multiple overlapping regions.

The position and size of each overlapping region can be determined by comparing the position and size of the non-DirectDraw and the DirectDraw regions of each shared application window with the position and size of each non-shared application window.

In step 610, the background region is determined. The background region is the area on the presenter's computer screen that is not occupied by a shared application window (i.e., not a non-DirectDraw or DirectDraw region). The background region includes areas of the presenter's computer screen that are occupied by non-shared application windows.

The background region can be determined by comparing the position and size of the non-DirectDraw and the DirectDraw regions of each shared application window with the position and size of the presenter's entire desktop.

In step 612, a screen shot of the image corresponding to the non-DirectDraw and DirectDraw regions of each shared application windows is captured. In this step, the image within each shared application window (i.e., non-DirectDraw and DirectDraw regions) is captured so that it can be provided to the viewer. This step is performed periodically (e.g., five times per second). Thus, as the image on the presenter's computer screen changes, these changes are immediately reflected on the viewer's computer screen.

The screen shot of the image corresponding to non-DirectDraw and DirectDraw regions can be captured by capturing portions of the frame buffer on the presenter's computer that correspond to the non-DirectDraw and DirectDraw regions. Since step 602 and 604 determines the sizes and positions of the non-DirectDraw and DirectDraw regions of shared application windows, the location of the shared application windows within the frame buffer are known.

In step 614, the position, size, and sequence of each shared application window and each non-shared application window is monitored. If the position, size, or sequence of a shared application window or a non-shared application window changes, then method 600 returns to step 602. If the position, size, and sequence of the shared application windows and the non-shared application windows do not change, then method 600 proceeds to step 612.

The position, size, and sequence of each shared application window and each non-shared application window on the presenter's computer screen can be dynamically monitored by monitoring and intercepting function calls made by the shared application to a graphics display subsystem (as described above).

In step 616, the screen shot of the image within the non-DirectDraw and the DirectDraw regions of each shared application window, if necessary, the position and size of each shared application window, the position and size of each overlapping region, and the position and size of the background region is transmitted to the viewer's computer. If the position, size, or sequence of the shared application windows and the non-shared application windows have not changed since the previous screen shot was transmitted to the viewer's computer, then the position and size of the shared application windows, the position and size of the overlapping regions, and the position and size of the background region do not have to be retransmitted to the viewer's computer. On the other hand, if the position, size, or sequence of the shared application windows or the non-shared application windows have changed since the previous screen shot was transmitted to the viewer's computer, then the updated position and size of the shared application windows, the updated position and size of the overlapping regions, and/or the updated position and size of the background region are transmitted to the viewer's computer. This ensures that the viewer's computer screen accurately reflects what is currently displayed on the presenter's computer screen. Prior to transmission, the screen shot of the images corresponding to each shared application window can be compressed using image compression techniques such as GZIP or JPEG.

Once the viewer's computer has received the screen shot of the image corresponding to the non-DirectDraw and the DirectDraw regions of each shared application window, and if transmitted, the position and size of each shared application window, the position and size of each overlapping region, and the position and size of the background region, viewer application sharing software 125 can display the image on the viewer's computer screen. To accomplish this, viewer application software 125 performs the following process. First, viewer application software 125 generates or draws a background region based on the position and size of the background region. The background region can be filled or painted with an arbitrary color or image. Second, viewer application software 125 generates or draws a window corresponding to the position and size of each shared application window. Third, viewer application sharing software 125 generates or draws the image corresponding to the non-DirectDraw and the DirectDraw regions of each shared application window inside of each shared application window. Fourth, viewer application software 125 generates or draws an overlapping region corresponding to the position and size of each overlapping region. The overlapping region can be filled or painted with an arbitrary color or image. Skilled artisans will recognize that this process can be modified to achieve the same result and that all such modifications are within the scope of the present invention.

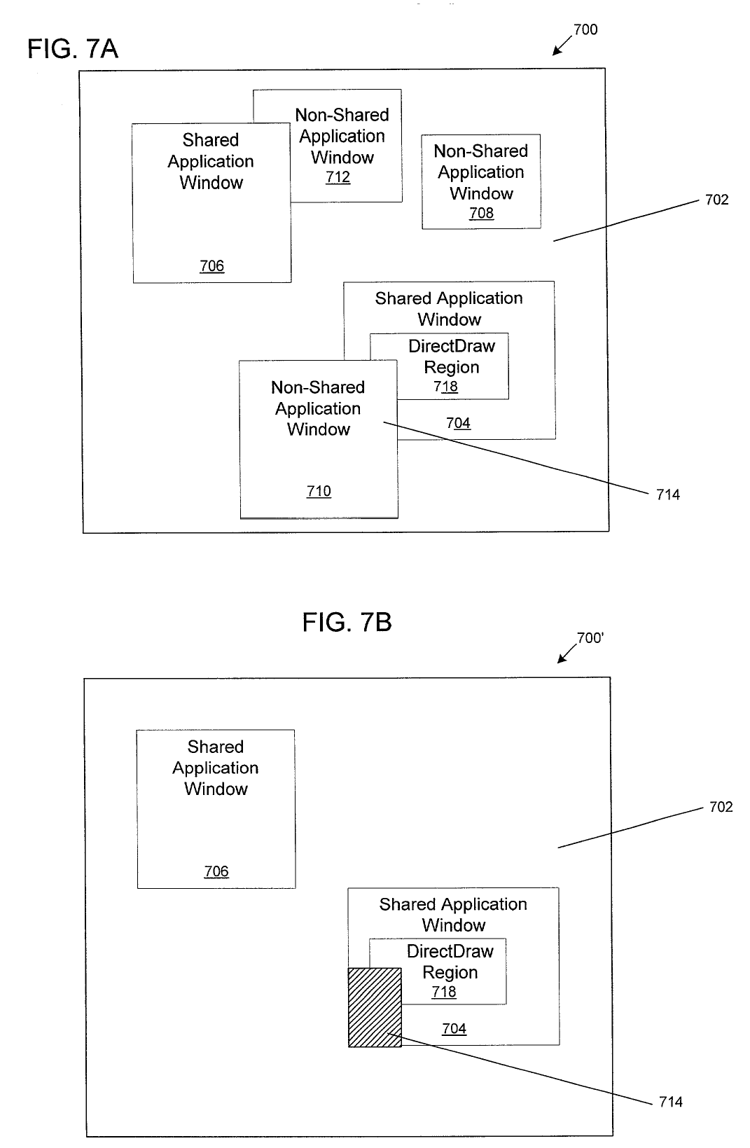

FIGS. 7A and 7B show an example of how application based screen sampling method 600 operates during a data conference. FIG. 7A shows a presenter's computer screen 700. Presenter's computer screen 700 includes background region 702, shared application windows 704 and 706, non-shared application windows 708, 710, and 712, and overlapping region 714. Shared application window 704 includes a DirectDraw region 718, which is a region drawn by DirectDraw. The region of shared application window 704 outside of DirectDraw region 718 is referred to as the non-DirectDraw region, which is a region that is not drawn by DirectDraw. FIG. 7B shows a viewer's computer screen 700′. Viewer's computer screen 700′ includes background region 702, shared application windows 704 and 706, and overlapping region 714. Shared application window 704 includes DirectDraw region 718. A portion of DirectDraw region 718 and non-DirectDraw region of shared application window 704 is obscured by overlapping region 714.

After a data conference has started, the presenter selects one or more applications to share with a viewer. Presenter application sharing software 115 receives the presenter's selections and then performs the DirectDraw application based sharing method of the present invention as follows. First, presenter application sharing software 115 determines the position and size of the non-DirectDraw regions within each shared application window on the presenter's computer screen 700 (step 602). To accomplish this, shared application window monitor 116 monitors function calls that define the positions and sizes of the non-DirectDraw regions of shared application windows 704 and 706. Second, presenter application sharing software 115 determines the position and size of the DirectDraw regions within each shared application window on the presenter's computer screen 700 (step 604). To accomplish this, DirectDraw monitor 118 monitors DirectDraw COM interface and intercepts information that defines the positions and sizes of the DirectDraw regions of shared application window 704. Third, presenter application sharing software 115 determines the position and size of each non-shared application window on the presenter's computer screen 700 (step 606). To accomplish this, non-shared application window monitor 117 monitors function calls that define the positions and sizes of non-shared application windows 708, 710, and 712. Fourth, presenter application sharing software 115 determines the position and size of the overlapping regions (step 608). Presenter application sharing software 115 can determine the overlapping regions by comparing the position and size of non-DirectDraw regions and the DirectDraw regions of shared application window 704 with the position and size of non-shared application window 710. Note that the portion of shared application window 706 that overlaps non-shared application window 712 is not an overlapping region since non-shared application window 712 does not overlap shared application window 706. Fifth, presenter application sharing software 115 determines the background region 702 (step 610). Presenter application sharing software 115 can determine the background region by comparing the positions and sizes of shared application windows 704 and 706 with the position and size of the entire computer screen 700. Sixth, presenter application sharing software 115 captures a screen shot of the image within non-DirectDraw and the DirectDraw regions of the shared application windows (step 612). Presenter application sharing software 115 can perform this step by capturing a screen shot of the image that corresponds to the position and size of shared application windows 704 and 706 (including the non-DirectDraw and the DirectDraw regions). Seventh, presenter application sharing software 115 determines whether the position, size or sequence of any shared application windows or any non-shared application windows have changed (step 614). Presenter application sharing software 115 can perform this step by monitoring function calls that define the position, size, and sequence of shared application windows 704 and 706 and non-shared application windows 708, 710, and 712. Since the position, size and sequence of the shared application windows and the non-shared application windows have not changed in this example, the presenter application sharing software 115 proceeds to step 216. Eighth, presenter application sharing software 115 transmits the screen shots of the image within non-DirectDraw and the DirectDraw regions of shared application windows 704 and 706, and, if necessary, the position and size of shared application windows 704 and 706, the position and size of overlapping region 714, and position and size of background region 702 (step 616). This example assumes that the position and size of shared application windows 704 and 706, the position and size of overlapping region 714, and position and size of background region 702 do not change. Thus the position and size of shared application windows 704 and 706, the position and size of overlapping region 714, and position and size of background region 702 only need to be transmitted to the viewer's computer once. After that, only the updated screen shots of the image within shared application windows 704 and 706 of the presenter's computer screen need to be periodically transmitted to the viewer's computer.

Application based screen sampling method 600 provides at least the following advantages. First, it allows a presenter to define or designate applications as shared applications and non-shared applications. Windows belonging to shared applications and non-shared applications are monitored and only windows belonging to shared application windows are displayed on a viewer's computer screen. Thus the presenter does not have to worry about inadvertently sharing an application window or a portion of an application window that the presenter does not intend to share with a viewer. Second, the presenter can now intentionally obscure a portion of a shared application window by placing a non-shared application window over the shared application window. Third, the presenter can share applications that generate images using DirectDraw.

It should also be recognized that step 604 of method 600 can be modified so that any COM interface (not just the DirectDraw COM interface) can be monitored. Thus, the present invention also provides general a method for monitoring any COM interface.

### Alternate Embodiments

The order in which the steps of the methods of the present invention are performed is purely illustrative in nature. The steps can be performed in any order or in parallel, unless otherwise indicated by the present disclosure. The methods of the present invention may be performed in hardware, firmware, software, or any combination thereof operating on a computer or computers of any type. Software embodying the present invention may comprise computer instructions in any form (e.g., source code, object code, interpreted code, etc.) stored in any computer-readable medium (e.g., ROM, RAM, magnetic media, compact disc (CD) in any form, DVD, etc.). Such software may also be in the form of a computer-readable data signal embodied in a carrier wave propagating on a conductive medium.

While particular embodiments of the present invention have been shown and described, it will be apparent to those skilled in the art that changes and modifications may be made without departing from this invention in its broader aspect and, therefore, the appended claims are to encompass within their scope all such changes and modifications as fall within the true spirit of this invention.

I claim:

1. A method for sharing an application, the method comprising:
determining a position and a size of a shared application window by monitoring function calls made by the application; and
capturing a screen shot of an image corresponding to the shared application window.

2. The method of claim 1 further comprising:
transmitting the position and the size of the shared application window to a viewer.

3. The method of claim 1 further comprising:
transmitting the screen shot to a viewer.

4. The method of claim 1 further comprising:
determining a position and a size of a non-shared application window by monitoring function calls made by the non-shared application; and
if the non-shared application window overlaps the shared application window, determining a position and a size of an overlapping region.

5. The method of claim 4 further comprising:
transmitting the overlapping region to a viewer.

6. The method of claim 1 further comprising:
determining whether the position or the size of the shared application window has changed by monitoring function calls made by the shared application; and
if the position or the size of the shared application window has changed, determining a new position and/or a new size of the shared application window.

7. The method of claim 1 further comprising:
periodically capturing an image corresponding to the shared application window.

8. The method of claim 7 further comprising:
periodically transmitting the captured image to the viewer.

9. A computer-readable storage medium storing a computer program executable by a computer, the computer program comprising computer instructions for:
determining a position and a size of a shared application window by monitoring function calls made by the application; and
capturing a screen shot of an image corresponding to the shared application window.

10. The computer readable storage medium of claim 9 further comprising computer instructions for:
transmitting the position and the size of the shared application window to a viewer.

11. The computer readable storage medium of claim 9 further comprising computer instructions for:
transmitting the screen shot to a viewer.

12. The computer readable storage medium of claim 9 further comprising computer instructions for:
determining a position and a size of a non-shared application window by monitoring function calls made by the non-shared application; and
if the non-shared application window overlaps the shared application window, determining a position and a size of an overlapping region.

13. The computer readable storage medium of claim 12 further comprising computer instructions for:
transmitting the overlapping region to a viewer.

14. The computer readable storage medium of claim 9 further comprising computer instructions for:
determining whether the position or the size of the shared application window has changed by monitoring function calls made by the shared application; and
if the position or the size of the shared application window has changed, determining a new position and/or a new size of the shared application window.

15. The computer readable storage medium of claim 9 further comprising computer instructions for:
periodically capturing the image corresponding to the shared application window.

16. The computer readable storage medium of claim 15 further comprising computer instructions for:
periodically transmitting the captured image to the viewer.

17. A data conferencing system comprising:
a presenter computer connected to one or more server computers via a global area network;
a viewer computer connected to the one or more server computers via the global area computer network; and
a computer program executable by the presenter computer, wherein the computer program comprises computer instructions for:
determining a position and a size of a shared application window by monitoring function calls made by the application; and
capturing a screen shot of an image within the shared application window.

18. The data conferencing system of claim 17 further comprising computer instructions for:
transmitting the position and the size of the shared application window to the viewer computer.

19. The data conferencing system of claim 17 further comprising computer instructions for:
transmitting the screen shot to the viewer computer.

20. The data conferencing system of claim 17 further comprising computer instructions for:
determining a position and a size of a non-shared application window by monitoring function calls made by the non-shared application; and
if the non-shared application window overlaps the shared application window, determining a position and a size of an overlapping region.

21. The data conferencing system of claim 20 further comprising computer instructions for:
transmitting the overlapping region to a viewer.

22. The data conferencing system of claim 17 further comprising computer instructions for:
determining whether the position or the size of the shared application window has changed by monitoring function calls made by the shared application; and
if the position or the size of the shared application window has changed, determining a new position and/or a new size of the shared application window.

23. The data conferencing system of claim 17 further comprising computer instructions for:
periodically capturing the image corresponding to the shared application window.

24. The data conferencing system of claim 23 further comprising computer instructions for:
periodically transmitting the captured image to the viewer computer.
